(19) United States
(12) Patent Application Publication
(10) Pub. No.: US 2014/0225497 A1
(43) Pub. Date: Aug. 14, 2014

(54) PRECHAMBER MODULE FOR A LASER SPARK PLUG AND METHOD FOR PRODUCING SAME

(71) Applicants: Pascal Woerner, Korntal-Muenchingen (DE); Joerg Englehardt, Ditzingen (Hirschlanden) (DE); Martin Weinrotter, Vitoria-Gasteiz (ES)

(72) Inventors: Pascal Woerner, Korntal-Muenchingen (DE); Joerg Englehardt, Ditzingen (Hirschlanden) (DE); Martin Weinrotter, Vitoria-Gasteiz (ES)

(21) Appl. No.: 14/232,177

(22) PCT Filed: May 29, 2012
(86) PCT No.: PCT/EP2012/059974

§ 371 Date: Apr. 23, 2014

(30) Foreign Application Priority Data
Jul. 12, 2011 (DE) 10 2011 079 020.9

(51) Int. Cl. H01T 13/54; H01T 13/50; H01T 21/02

(52) U.S. Cl. CPC H01T 13/54; H01T 21/02; H01T 13/50
USPC 313/143; 29/428

(57) ABSTRACT

A prechamber module for a laser spark plug, the prechamber module having a fastening region for the detachable fastening of the prechamber module to the laser spark plug. The prechamber module, in an end region, facing away from the combustion chamber, has a diaphragm arrangement, which borders on an inner chamber of the prechamber module in the axial direction, and has an orifice for the irradiation of laser radiation from the laser spark plug into the inner chamber of the prechamber module.

### FIELD OF THE INVENTION

The present invention relates to a prechamber module for a laser spark plug, the prechamber module having a fastening region for the detachable fastening of the prechamber module to the laser spark plug. The present invention further relates to a production method for such a prechamber module.

### BACKGROUND INFORMATION

A prechamber module of the type mentioned at the outset is discussed in WO 2010/094551 A1, for example.

### SUMMARY OF THE INVENTION

It is an object of the present invention to improve a prechamber module of the type mentioned at the outset and a corresponding production method for it to the extent that the simple equipment of a laser spark plug with the prechamber module is possible, and at the same time an improved protection of a combustion chamber window or other optical component of the laser spark plug from dirt particles starting from the prechamber module is assured.

According to the present invention, this object is attained by the prechamber module, of the type named at the outset, in that the prechamber module has diaphragm arrangement in an end region facing away from the combustion chamber, which border the internal space of the prechamber module in the axial direction and have an orifice for irradiating laser radiation from the laser spark plug into the inner chamber of the prechamber module.

The diaphragm arrangement according to the present invention advantageously enable the irradiation of laser radiation from the laser spark plug into the inner chamber of the prechamber or the prechamber module, in order to ignite an ignitable air/fuel mixture that is present there, while at the same time at least one radially outer range of a combustion chamber window of the laser spark plug is effectively covered by the diaphragm arrangement, so that the entry of dirt particles onto an outer surface of the combustion chamber window during the use of the prechamber module according to the present invention is reduced.

The geometry of the diaphragm arrangement according to the present invention is particularly advantageous, particularly the geometry of the opening of the diaphragm arrangement, which is adapted to the ray path starting from the laser spark plug, the opening having as small as possible a cross sectional area, and thus providing efficient protection of the combustion chamber window from dirt particles, originating from the prechamber, such as oil ashes.

In one specific embodiment it is provided that the orifice in the diaphragm arrangement is essentially frustoconical, a cover area being situated in the vicinity of the inner chamber of the prechamber module, and a floor area, which is greater than the cover area, being situated in an area of the diaphragm arrangement facing away from the prechamber. This configuration brings about a particularly good adjustment of the orifice of the diaphragm arrangement to the beam geometry, which is usually conical, of the laser radiation provided by the laser spark plug and irradiated into the inner chamber of the prechamber module.

As a result of another specific embodiment, a further improvement may be achieved in that the diaphragm arrangement, in the vicinity of the cover area, have, at least in sections, a convex surface, whereby there comes about advantageously a deflection of fluid particle flows and dirt particle flows, which are directed from an inner chamber of the prechamber module to the orifice of the diaphragm arrangement. In this way, advantageously, at least a part of these fluid particle flows and dirt particle flows is able to be deflected into a radially inside direction, whereby it is prevented that the respective particles deposit on the outer surface of the combustion chamber window of a laser spark plug equipped with the prechamber module.

In one further advantageous specific embodiment it is provided that the diaphragm arrangement have an essentially step-shaped recess in a radially outer region, which advantageously makes possible a reliable form-locking contact-making of the prechamber module to a corresponding accommodation region of the laser spark plug.

In another advantageous specific embodiment, the diaphragm arrangement are developed as one piece with the prechamber module. For example, both the prechamber module (without the diaphragm arrangement) and the diaphragm arrangement may be produced as separate components. Thereafter, the two separate components may be brought into a contact position to each other in the axial direction, and connected by a suitable joining method, for instance, by welding, particularly ultrasonic welding and/or laser welding and/or friction welding.

In a particularly advantageous manner, for this purpose, the components prechamber module, diaphragm arrangement each have corresponding end faces, which with respect to their geometry are developed so that they at least partially cooperate with the corresponding end face of the other component.

Provided the diaphragm arrangement are not developed as one piece with the prechamber module, it may be provided, according to one further advantageous specific embodiment that the diaphragm arrangement are developed in such a way that, through the prechamber module, which is fastenable, using its fastening region, to the laser spark plug, is able to be braced, at least in the axial direction, in a corresponding accommodation opening of the laser spark plug.

In still another advantageous specific embodiment, it is provided that a joining location between the prechamber module and the diaphragm arrangement be at a greater distance from a region of the prechamber module than the fastening region. Provided the joining location is radially farther inside than the fastening region for fastening the prechamber module to the laser spark plug, there comes about thereby an especially efficient protection of the joining location from outer effects, since the joining location is coaxially surrounded by an accommodation region, of the laser spark plug, which cooperates with the fastening region of the prechamber module according to the present invention.

In a further advantageous specific embodiment, it is provided that the diaphragm arrangement are developed so that, at least in regions, they also border the inner chamber of the prechamber module in the radial outward direction, whereby additional degrees of freedom are possible for the geometrical embodiment of the prechamber or the prechamber module.

In yet another advantageous specific embodiment, it is provided that the prechamber module have a greater wall thickness in the fastening region, particularly in the radial direction, than at a contact location or joining location between the prechamber module and the diaphragm arrangement. Because of this, a stable fastening of the prechamber module to the laser spark plug is made possible, while at the same time a decreased material cost results on the mechanical connection of the prechamber module to the diaphragm arrangement.

As an additional attainment of the object of the present invention, a method for producing a prechamber module is given as described herein.

Further advantageous developments of the present invention are the subject matter of the further descriptions herein.

Additional features, application options and advantages of the present invention result from the following description of exemplary embodiments of the present invention, which are shown in the figures of the drawings. For this purpose, all of the described or illustrated features form the subject of the present invention, either alone or in any combination, irrespective of their combination in the patent claims or their antecedent references and also irrespective of their individual formulation and illustration in the description and in the drawings.

### BRIEF DESCRIPTION OF THE DRAWINGS

FIG. 1 shows schematically a partial cross section of a first specific embodiment of a prechamber module according to the present invention.

FIG. 2 shows schematically a partial cross section of a prechamber module according to the present invention, in the installed position on a laser spark plug.

FIG. 3 shows a simplified flow chart of a specific embodiment of the method according to the present invention.

### DTEAILED DESCRIPTION

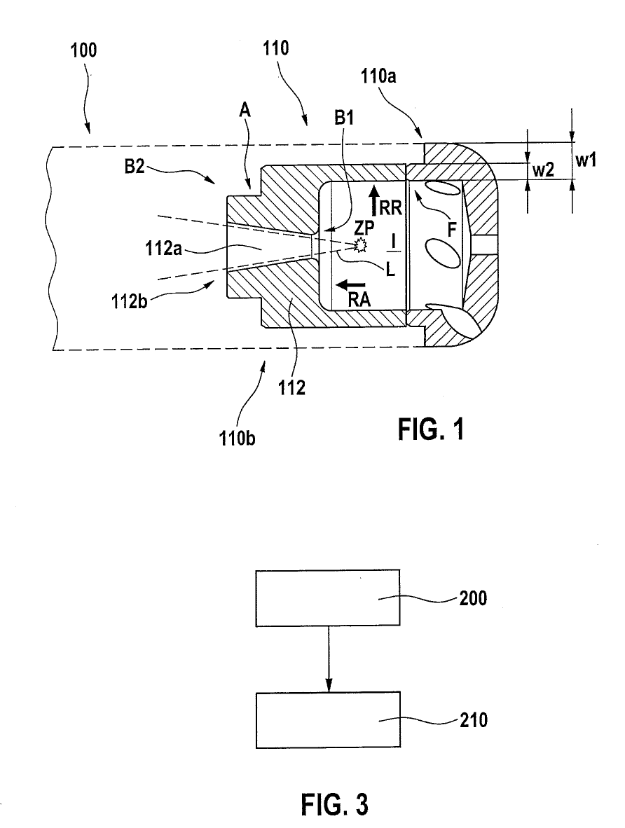

FIG. 1 shows schematically a partial cross section of a prechamber module 110 according to the present invention, which is provided to be applied on an end region, facing the combustion chamber, of a laser spark plug 100 shown schematically in FIG. 1

Prechamber module 110 primarily implements the function known per se of a prechamber for laser spark plug 100. For this purpose, prechamber module 110 is fastened in a fastening region 110a on laser spark plug 100 or a housing of laser spark plug 100. The fastening between prechamber module 110 and laser spark plug 100 may take place using a detachable connection, for instance, using a press fit or a screw connection or the like, which lowers the maintenance costs of a laser spark plug 100 thus equipped, because prechamber module 110 is able to be exchanged flexibly.

The simple exchange of prechamber module 110 with respect to laser spark plug 100 particularly also makes possible the efficient cleaning of possibly present optical components, such as a combustion chamber window (not shown), of laser spark plug 100, which is also situated in the accommodation region of laser spark plug 100 that accommodates prechamber module 110, and at least in the insertion position of the prechamber module 110 on laser spark plug 100 is difficult to access, as a rule.

According to the present invention, prechamber module 110 has diaphragm arrangement 112, which are situated in an end region 110b of prechamber module 110, that is, at the left in FIG. 1. Diaphragm arrangement 112 border inner chamber I of prechamber module 110 in the axial direction RA, and at the same time have an orifice 112a for irradiating laser radiation L from laser spark plug 100 into inner chamber I of prechamber module 110.

Because of the decreased opening cross section of orifice 112a of diaphragm arrangement 112 compared to inner chamber I of prechamber module 110, the entry of dirt particles and other polluting agents from inner chamber I of the prechamber or prechamber module 110 on to optical components of laser spark plug 100, which in FIG. 1 are located to the left of prechamber module 110 (not shown) is reduced, so that the service life of the combustion chamber window and the optical components of laser spark plug 100, which have a prechamber module 110 according to the present invention, is increased.

In a particularly advantageous manner, orifice 112a is developed to be approximately frustoconical, whereby an optimal adaptation of its shape to laser radiation L usually being approximately conical is present, which is provided by laser spark plug 100 and is irradiated through orifice 112a of diaphragm arrangement 112 through into inner chamber I of prechamber module 110.

In a particular manner, a cover area of orifice 112a of diaphragm arrangement 112 is situated in the region of diaphragm arrangement 112 facing the prechamber, that is, to the right of orifice 112a in FIG. 1. Compared to that, the floor area of orifice 112a, which is larger than the cover area, is situated at the left-hand end of prechamber module 110 in FIG. 1, i.e. in an end region 112b facing laser spark plug 100, of prechamber module 110.

In one particularly advantageous specific embodiment, in a region B1 of the cover area of orifice 112a, the surface of diaphragm arrangement 112 is formed to be convex, at least in sections, whereby a particularly efficient reduction or deflection of fluid flows comes about from inner chamber I of prechamber module 110 to orifice 112a of the diaphragm arrangement, that is, to the left in FIG. 1. For example, a particle flow moving in the approximately axial direction from right to left, in FIG. 1 towards opening 112a through the convex surface areas of diaphragm arrangement 112 is at least partially deflected in a radially inner direction, whereby the axial flow proportion is correspondingly reduced.

In one further advantageous specific embodiment, diaphragm arrangement 112, in a radially outer region B2, have an essentially step-shaped recess A, which enables simplified assembly or best fit of prechamber module 110 in the correspondingly shaped accommodation region of laser spark plug 100.

In another particularly advantageous specific embodiment, it is provided that diaphragm arrangement 112 are developed in one piece with prechamber module 110, which may be achieved, for example, by providing two separate components prechamber module 110, diaphragm arrangement 112 and subsequently joining the two components 110, 112 to each other in the range of joining location F. In this case, prechamber module 110 together with diaphragm arrangement 112, as a unit replacement part, is able to be separated from laser spark plug 100 or connected to laser spark plug 100, cf. connecting region 110a.

In yet another advantageous specific embodiment, prechamber module 110 and diaphragm arrangement 112 represent components that are separate from each other, and the contact area between components 110, 112 is developed so that diaphragm arrangement 112 are able to be braced, at least in the axial direction, in a corresponding accommodation opening of laser spark plug 100. To do this, for example, correspondingly cooperating end face regions in prechamber module 110 and diaphragm arrangement 112 may be provided, which overlap at least partially, whereby a force transfer in the axial direction is made possible from prechamber module 110 that is able to be connected to laser spark plug 100 to diaphragm arrangement 112.

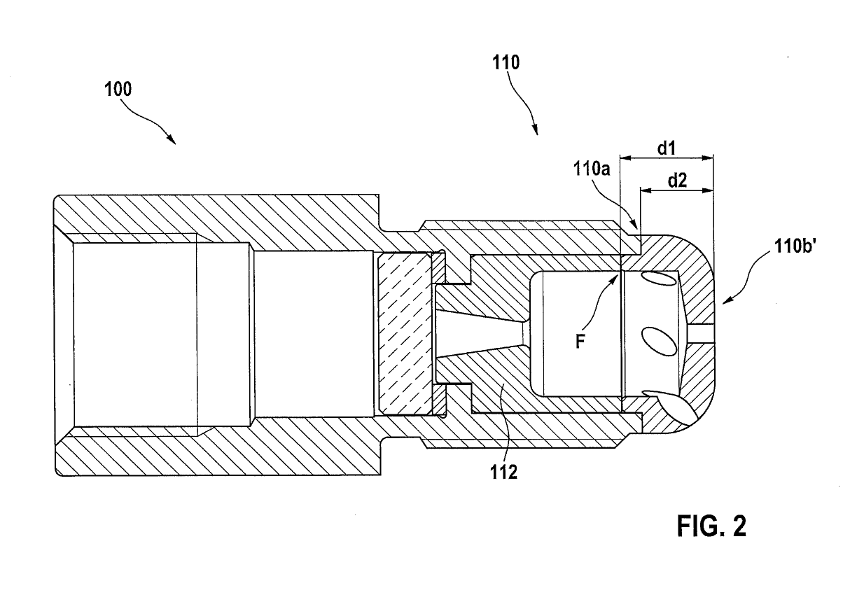

In a still further advantageous specific embodiment, in which prechamber module 110 and diaphragm arrangement 112 are connected as one piece, it is provided that joining location F between prechamber module 110 and diaphragm arrangement 112 is at a farther distance from an end region 110b′ of prechamber module 110 facing the combustion chamber, than is fastening region 110a, cf. FIG. 2.

Joining location F, in the present specific embodiment, is at a first distance dl from end region 110b′ of prechamber module 110, that faces the combustion chamber, while fastening region 110a, via which prechamber module 110 may be connected detachably to laser spark plug 100, is at a second distance d2<d1 from end region 110b′ of prechamber module 110.

In this configuration, fastening region 110a and joining region F advantageously do not overlap in the axial direction, so that a particularly stable configuration comes about, mechanically speaking.

In addition, in the case of a further variant of the present invention, a wall thickness w2 of prechamber module 110 in joining region F (FIG. 1) may be developed to be less than a wall thickness w1 of the remaining prechamber module 110.

In a further advantageous specific embodiment, it is provided that the diaphragm arrangement 112 are developed so that, at least in regions, they also border on inner chamber I of prechamber module 110 outwards in the radial direction RR (FIG. 1), whereby additional degrees of freedom are given for the geometry of the prechamber or prechamber module 110.

One further aspect of the present invention relates to a production method for a prechamber module 110. According to the present invention, on prechamber module 110, at an end region 110b, facing away from the combustion chamber, diaphragm arrangement 112 are situated which border on inner chamber I of prechamber module 110 in the axial direction RA (FIG. 1), and have an orifice 112a for the irradiation of laser radiation L from laser spark plug 100 into inner chamber I of prechamber module 110, especially onto ignition point ZP.

The single piece development of prechamber module 110 may, for instance, be obtained by first joining separately produced components prechamber module 110, diaphragm arrangement 112 to each other, via welding, for example. In one particular specific embodiment of the method according to the present invention, at most about 10% to 20% of an axial contact surface between prechamber module 110 and diaphragm arrangement 112 are welded to each other, in particular, by welding points that are situated equidistant to one another.

Alternatively, diaphragm arrangement 112 may also be connected to prechamber module 110 by a press fit.

Fastening region 110a of prechamber module 110 may be configured so that it enables a screw connection having a corresponding accommodation region of laser spark plug 100.

FIG. 3 shows a simplified flow chart of a specific embodiment of the operating method according to the present invention. In a first step 200, a prechamber module 110 is provided. In a subsequent step 210, diaphragm arrangement 112 are situated, in the manner described before, on prechamber module 110, for instance, by way of clamping by the axial application of force or a joining process such as welding.

A detachable connection of prechamber module 110b to laser spark plug 100 may be implemented, for example by a screw connection, in which fastening region 110a has an external thread, for example, which is able to function together with a corresponding inner thread in a housing of laser spark plug 100. A clearance fit or a transition fit between components 100, 110 is also conceivable, the components being fixed with respect to each other using a set-screw.

In one further aspect of the present invention, it is further possible to provide a laser spark plug with which diaphragm arrangement are associated which themselves are not a component of a prechamber module 110. Because of that, a laser spark plug is able to be implemented which nevertheless has diaphragm arrangement for the protection of the combustion chamber. In this variant, the diaphragm arrangement may be configured to be detachable from the laser spark plug.

1-15. (canceled)

16. A prechamber module for a laser spark plug, comprising:
a prechamber module arrangement having a fastening region for detachably fastening the prechamber module arrangement to the laser spark plug;
a diaphragm arrangement, in an end region facing away from a combustion chamber, which borders on an inner chamber of the prechamber module arrangement in an axial direction, and which has an orifice for the irradiation of laser radiation from the laser spark plug into the inner chamber of the prechamber module arrangement.

17. The prechamber module of claim 16, wherein the orifice in the diaphragm arrangement is essentially frustoconical in shape, a cover area being situated in the vicinity of the inner chamber of the prechamber arrangement, and a floor area, which is greater than the cover area, is situated in a region of the diaphragm arrangement facing away from the prechamber module arrangement.

18. The prechamber module of claim 17, wherein the diaphragm arrangement has a convexly shaped surface, at least in sections, in the region of the cover area.

19. The prechamber module of claim 16, wherein the diaphragm arrangement has an essentially step-shaped recess in a radially outer region.

20. The prechamber module of claim 16, wherein the diaphragm arrangement is configured as one piece with the prechamber module arrangement.

21. The prechamber module of claim 16, wherein the diaphragm arrangement is configured as a separate component from the prechamber module arrangement and are configured so that they are able to be braced by the prechamber module arrangement at least in the axial direction in a corresponding accommodation opening of the laser spark plug.

22. The prechamber module of claim 16, wherein the prechamber module arrangement, which is a separate component, is joined or welded to the diaphragm arrangement, which is also a separate component.

23. The prechamber module of claim 22, wherein a joining location between the prechamber module arrangement and the diaphragm arrangement is at a greater distance from an end region of the prechamber module arrangement, that faces the combustion chamber, than the fastening region.

24. The prechamber module of claim 16, wherein the diaphragm arrangement is configured so that, at least in regions, they border from the outside the inner chamber of the prechamber module arrangement even in the radial direction.

25. The prechamber module of claim 16, wherein the prechamber module arrangement in the fastening range has a greater wall thickness than at a contact location or a joining location between the prechamber module arrangement and the diaphragm arrangement.

26. A method for producing a prechamber module for a laser spark plug, the method comprising:
providing a prechamber module arrangement having a fastening region for detachably fastening the prechamber module arrangement to the laser spark plug, wherein on the prechamber module arrangement, a diaphragm arrangement is situated in an end region facing away from a combustion chamber, which borders on an inner chamber of the prechamber module arrangement in an axial direction and having an orifice for irradiation of the laser radiation from the laser spark plug into the inner chamber of the prechamber module arrangement.

27. The method of claim 26, wherein the diaphragm arrangement is joined by welding to the prechamber module arrangement.

28. The method of claim 27, wherein a maximum of about 10 percent to 20 percent of an axial contact surface between the prechamber module arrangement and the diaphragm arrangement is welded together by welding points, in particular, which are situated equidistant with respect to one another.

29. The method of claim 26, wherein the diaphragm arrangement is connected by a press fit to the prechamber module arrangement.

30. The method of claim 26, wherein the prechamber module arrangement is screwed to the laser spark plug in the fastening region.
